(19) United States
(12) Patent Application Publication
(10) Pub. No.: US 2005/0045529 A1
(43) Pub. Date: Mar. 3, 2005

(54) Vortex inducing rotor for screening apparatus for papermaking pulp

(75) Inventors: Richard G. Meese, Wilmington (DE); Brian J. Gallagher, Litchfield, NH (US); Bruce R. Crossley, Pittsfield, MA (US); James P. Burns JR., Hollis, NH (US)

Correspondence Address: JAMES EARL LOWE, JR., 15417 W NATIONAL AVE # 300, NEW BERLIN, WI, 53151, US

(73) Assignee: GL&V Management Hungary Kft

(21) Appl. No.: 10/653,709

(22) Filed: Sep. 2, 2003

(51) Int. Cl. B07B 1/52; B07B 1/04

(52) U.S. Cl. 209/273; 209/270; 210/413; 162/232

(57) ABSTRACT

A rotor having a longitudinal axis of rotation and including an outer surface adjacent a screen surface. The rotor also includes a plurality of sets of radially extending, relative to the rotor axis, adjacent vane members attached to the rotor surface, each set including at least four adjacent vane members with equally spaced apart and parallel trailing edges ending in a common plane. The two outermost vane members have leading edges forward of the two most inside vane members, with the leading edges forward of the two most inside vane members being angled toward its next adjacent vane. The height of the two innermost vane members is about half of the height of the two outermost vane members. Each of the outermost vane members is angled relative to the circumferential direction of travel of the rotor by each of the outermost having vane members with a leading edge that is angled relative to its trailing edge. Each of the vane members has a leading edge forming an acute angle relative to the surface of the rotor and has a top edge with the same radius of curvature as the screen. The plurality of sets of vane members are spaced out throughout a screening chamber defined between the rotor surface and the screen in the direction of the rotor axis. The rotor outer surface does not have any longitudinally extending lifting bodies that produce pressure pulses throughout the screening chamber.

### BACKGROUND OF THE INVENTION

This invention relates generally to machinery for screening paper-making pulp and, more particularly, to a screening apparatus having an enhanced rotor for promoting screening efficiency together with power conservation.

The Pulp and Paper Industry uses pressure screens to separate undesirable materials from usable fiber in the Industries various processes. The ideal embodiment of a pressure screen would remove all undesirable materials without the loss of desired fibers, without requiring any additional dilution of the fiber suspension, and with the minimum possible power consumption. As actually practiced in the Industry, screens with apertures sufficiently small to remove the undesirable particles are prone to plugging with fiber, fiber flocs, and debris. Plugging of the screen apertures eliminates the passage of all fiber. To allow the screen to operate, the screen must be cleared of potentially blocking materials.

Numerous variations of pressure screen design exist. Most pressure screens are fed with the fiber suspension to be cleaned in the interior of the screen plate, which is cylindrical in shape. The rotor, containing pulse generating elements, rotates inside the cylindrical screen. Other variations include rotating screen plates with stationary rotor elements, and pressure screens that are fed from the outside with the cleaned fiber suspension collected in the interior of the cylindrical screen.

Rotor construction also varies greatly based on the particular screen design, but all rotors have in common an element or elements that pass in close proximity to the surface of the screen cylinder. In all cases there is a differential in speed between the rotating component and the fixed component in the rotor—screen cylinder combination. The established design practice is to configure the rotor element such that the speed differential generates a positive pressure pulse preceding the passage of the rotor and a negative pressure pulse beginning at the point of closest proximity of the rotor to the screen cylinder surface. The pulse is measured at the surface of the screen cylinder directly over the rotor element as it passes the measurement sensor. Additionally, for some screening applications, the pressure trace is also measured several pipe diameters away from the screen body in the screen accepts piping.

Conventional thinking and prior art practice has utilized the positive pressure pulse trace to provide turbulence and disruptive shear stress to break pulp flocs so individual fibers could pass through the screen cylinder apertures. This disruption of flocs is necessary since flocs are 2-5 millimeters in diameter and typical screen cylinder apertures are 1.5 millimeters or smaller for holed screens and frequently as small as 0.15 millimeters in width for slotted screens.

The negative pulse component of the pressure trace is utilized to create a flow reversal through the screen cylinder. This has the function of drawing fluid back to flush the apertures and to disrupt fiber mat formation on the surface of the screen. But such pulse generation can have several negative effects. For example, significant energy is required in order to produce the pulses, and the rotor structure to create such pulses can add to the expense of making the rotors.

In some instances, pulses can have a negative influence on the screening process. For example, a final pulp screening occurs prior to the headbox where the pulp is about to enter the final stages of the paper making process. Any pressure variations caused by pressure pulses can cause uneven forming of the pulp, with the result that the paper can become alternately thick and thin in spots. A rotor that aids the screening process prior to the headbox without any pressure pulses would produce an improvement in the even forming of the paper.

To reduce the magnitude of the effects described above, many machines are now made with closed rotors, that is, rotors having a full cylindrical surface on which projections and depressions are directly attached without support arms to generate localized pressure pulsations. Depending upon their specific geometries, these may offer lower specific power consumption than cage rotors; and, because the bumps and depressions are distributed over the rotor surface, the pressure pulsations are distributed about the screen plate surface and do not concentrate alternating stresses along the aperture pattern.

This invention is an improvement to the hydrodynamic device shown in Young et al U.S. Pat. No. 5,497,886. The 5,497,886 patent discloses a hydrodynamic device for generating negative pressure excursions in a pulp slurry during fine screening, including a plurality of half-foil or lifting members disposed on a substantially cylindrical outer surface of a rotor, the rotor being mounted within and co-axial with a substantially cylindrical screen having a circumferentially continuous apertured zone to define an annular screening chamber between the rotor and the screen, the half-foil members being so arrayed as to sweep across the full axial extent of the apertured zone on the screen with each revolution of the rotor.

In one embodiment of the 5,497,886 patent, as shown in FIGS. 4c through 4g and 5, a constant height barrier or fence was added to the half-foil members to delay the axial inflow of pulp into the negative pressure zone created by the half-foils.

### SUMMARY OF THE INVENTION

One of the objects of this invention is to create a rotor that can keep a screen working properly without the creation of pressure pulses that can waste energy and create uneven flow of pulp through the screen.

Another of the objects of this invention is to create a rotor that keep a screen working properly while using a third less energy at the same rotor speed than traditional rotors, the rotor speed being measured at the part or tip of the rotor closest to the screen surface. This is accomplished by putting the same amount of energy into the flow across the screen surface, but by doing so with a mixing vortex without a significant pressure pulse.

This invention provides a rotor that creates vortices that create flow across the screen surface that keep the apertures open, while at the same essentially eliminating pressure pulses. The vortices created by the rotor of this invention cover a greater extent of the surface of the rotor than the pulses created by traditional rotors, and this further increases the cleaning ability of the rotor.

By placing the vane structures on the rotor with a slight overlap between successive vane structures, the direction of flow of the mixing vortices can be changed with each successive group of vane members. This produces the result of improving the removal of obstructive material from the screen because of the reversal of the cleaning flow across the screen.

The vane member height is such that the top of the vane is close to the screen surface, but with the necessary clearance for avoiding any collisions with the screen surface. If the top of the vane is too far from the screen surface, then vortices will not be as strong and will not keep the screen clear.

More particularly, the preferred embodiment of this invention provides a rotor adapted for use in a hydrodynamic device comprising a screen having a circumferentially continuous apertured zone, the rotor having a longitudinal axis of rotation and including an outer surface adjacent the screen surface. The rotor also includes a plurality of sets of radially extending, relative to the rotor axis, adjacent but spaced apart vane members attached to the rotor surface, each set including at least one, but typically four adjacent vane members with equally spaced apart and parallel trailing edges ending in a common plane. In other embodiments, the trailing edges may be located in different planes. The two outermost vane members have leading edges forward of the two most inside vane members, with the leading edges forward of the two most inside vane members being angled inward toward its next adjacent vane. The circumferential length of the two innermost vane members is about half of the circumferential length of the two outermost vane members. Each of the outermost vane members is angled relative to the circumferential direction of travel of the rotor by each of the outermost vane members having a leading edge that is angled relative to its trailing edge. Each of the vane members has a leading edge forming an acute angle relative to the surface of the rotor and has a top edge with the same radius of curvature as the screen surface. The rotor is mounted within and co-axial with the screen to define a screening chamber between the rotor surface and the screen surface, and the plurality of sets of vane members are spaced out throughout the screening chamber in the direction of the rotor axis. The rotor outer surface does not have any longitudinally extending lifting bodies that produce pressure pulses throughout the screening chamber.

The foregoing and other aspects will become apparent from the following detailed description of the invention when considered in conjunction with the accompanying drawing figures.

### BRIEF DESCRIPTION OF THE DRAWINGS

FIG. 1 is a perspective view, partially in section, illustrating a generalized embodiment of a pulp screening device and the overall structure of such a machine that includes an improved rotor of this invention.

FIG. 2 is a plan view of the rotor of this invention, with the rotor shell flattened out to show the arrangement of vane member sets.

FIG. 3 is a perspective view of a set of vane members.

FIG. 4 is a top view of the set of vane members shown in FIG. 3, with lines added to symbolize the vortices created by the vane members.

FIG. 5 is an end view taken along the line 5-5 of FIG. 4 showing the orientation of the free vortices created by the vane members.

FIG. 6 is a bottom view of the screen and rotor of FIG. 1.

Before one embodiment of the invention is explained in detail, it is to be understood that the invention is not limited in its application to the details of the construction and the arrangements of components set forth in the following description or illustrated in the drawings. The invention is capable of other embodiments and of being practiced or being carried out in various ways, particularly with respect to construction of various forms of single or multiple vanes and/or fences that may be used to generate vortices. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Further, it is to be understood that such terms as “forward”, “rearward”, “left”, “right”, “upward” and “downward”, etc., are words of convenience and are not to be construed as limiting terms.

### DETAILED DESCRIPTION OF THE PREFERRED EMBODIMENT

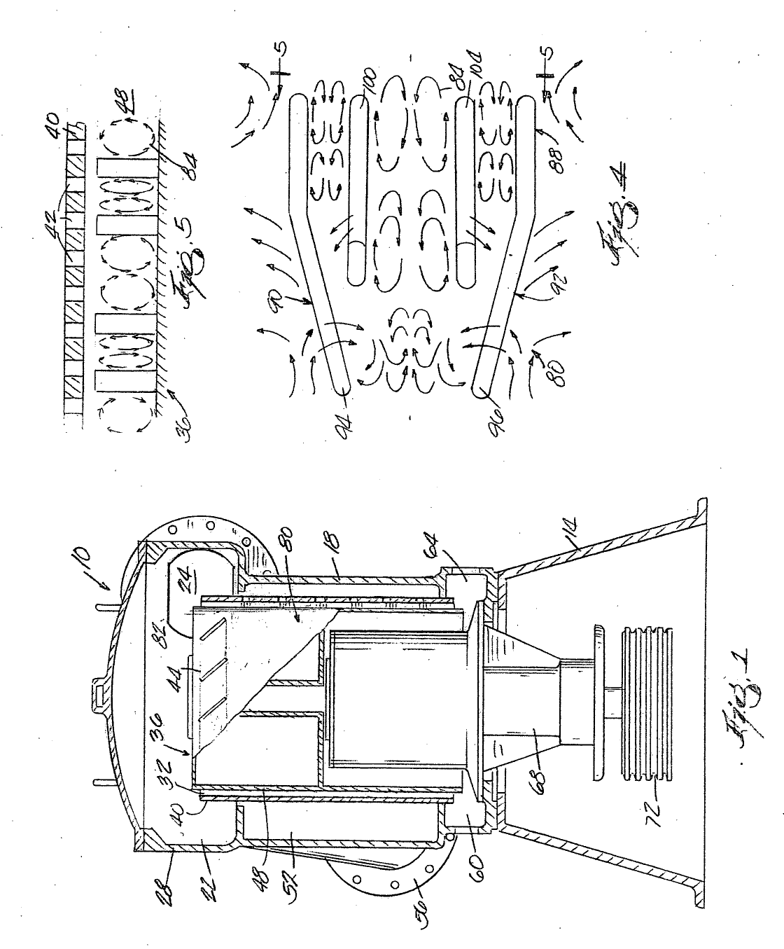

Referring to FIG. 1, common features of a hydrodynamic device such as pulp screening equipment can be seen. A screening apparatus 10 is made up of a base 14 upon which a housing 18 is mounted. (The apparatus shown here is vertically oriented, but it is known that a screening apparatus may be in any orientation between horizontal and vertical.) Housing 18 has an end mounted inlet chamber 22 with a pulp inlet 24 through which pulp is tangentially fed for screening. The pulp flows around and over inlet wall 28 into pulp entrance 32 which is defined by the annular space that forms a screening chamber between the portion of rotor 36 projecting above the perforated portion of a screen 40.

Rotor 36 has a closed top and a generally cylindrical surface 44, and the screen 40 has apertures 42 through which accepted fiber along with pulp liquor has a normal outflow. More particularly, the screen 40 is a cylindrical screen having a circumferentially continuous apertured zone. The annular space between rotor 36 and screen 40 defines a screening chamber 48, while the space outboard of the screen 40 contains accepts chamber 52 which is drained by accepts discharge 56. Below accepts chamber 52 and screening chamber 48 is rejects chamber 60 which empties through rejects discharge 64. Rotor 36 is rotated by a shaft, which extends through a sealed center column 68 and which is driven by a prime mover (not shown) through drive pulley 72.

Mounted on the surface 44 of the rotor 36 is a set 80 of four vane members. The rotor 36 is mounted within and co-axial with the screen 40, and the plurality of sets 80 of vane members are spaced out throughout the screening chamber in the direction of the rotor axis. The rotor outer surface 44 does not have any longitudinally extending lifting bodies that produce pressure pulses throughout the screening chamber 48. Or, in other words, the vane members extend radially directly from the rotor outer surface 44.

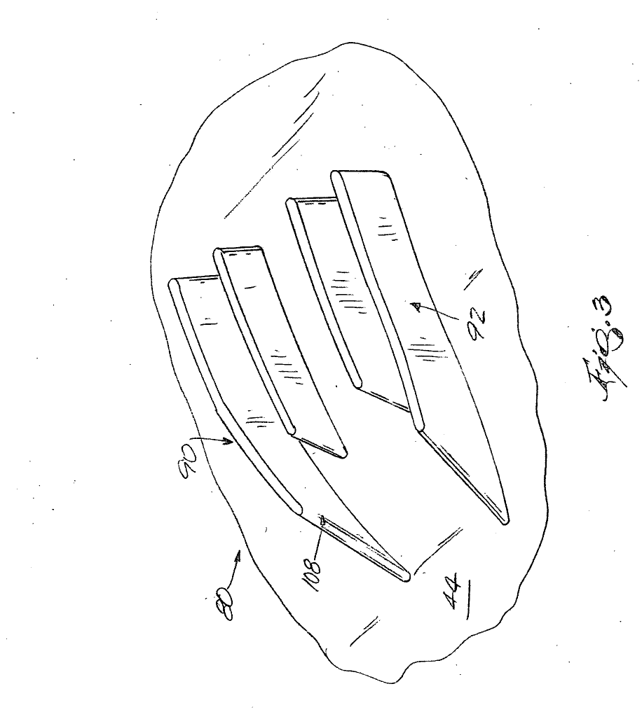

As shown in FIGS. 5 and 6, the clearance over the tops of these vane members produces a plurality of counter-rotating free vortices 84 whose length is determined by the rotational speed of the rotor 36. The vortices 84 are created by a high pressure area forward of the angled leading edge of the outermost vane members and a low pressure area on the opposite side of the outermost vane members.

As shown in FIG. 2, the next set 80 of vane members is placed at the end of the vortices produced by the preceding set. However, the vane members are positioned higher or lower on the axis of the hub relative to the preceding vane members. On a circumferential line around the rotor surface 44, the vortices produced by this next set of vane members would be rotating in the opposite direction from those that immediately preceded it. The overall pattern of placement of vane members on the entire rotor 36 is such that the entire surface of the screen cylinder is swept by the generated vortices that rotate in alternating directions. In the preferred embodiment, angled vanes 82 can be added to the top of the rotor in order to aid in initial movement of the pulp through the screening chamber.

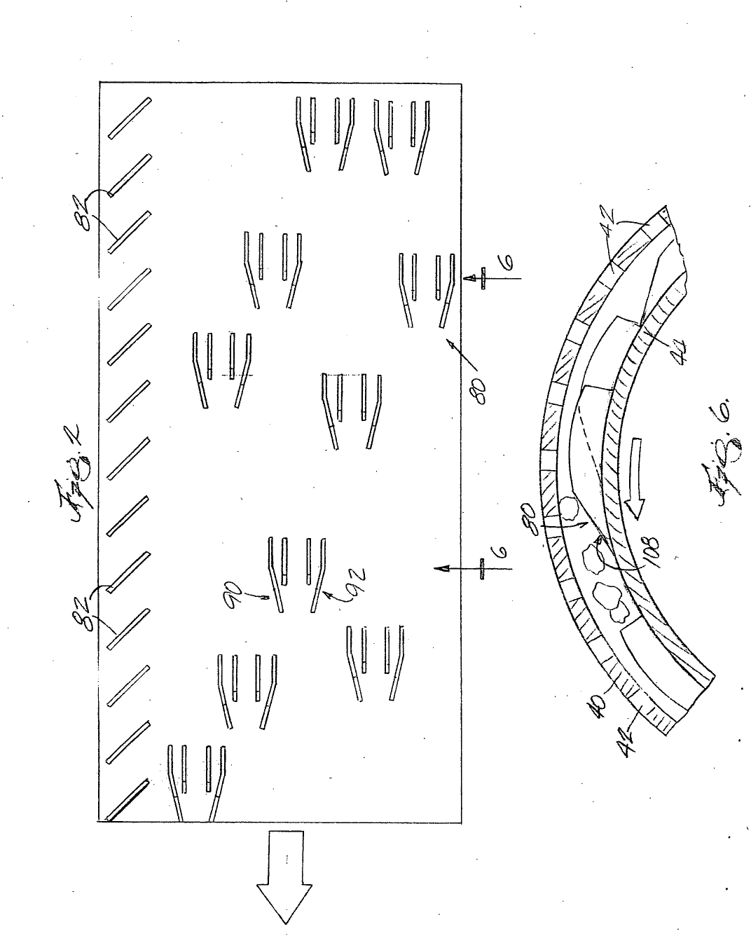

More particularly, as shown in FIG. 1, the screen 40 has a circumferentially continuous apertured zone, and the rotor has a longitudinal axis of rotation and includes, as shown in FIG. 6, the outer surface 44 adjacent the surface of the screen 40. More particularly, each set 80 of radially extending, relative to the rotor axis, adjacent vane members is attached to the rotor surface 44, and each set includes at least four adjacent vane members with equally spaced part, as shown in FIGS. 3 and 4, and parallel trailing edges 88 ending in a common plane. In other embodiments (not shown), the location of the trailing edges can be located in other positions.

The two outermost vane members 90 and 92 have leading edges 94 and 96, respectively, forward of the two most inside vane members 100 and 104, with the leading edges forward of the two most inside vane members 100 and 104 being angled toward its next adjacent vane member. The height of the two innermost vane members 100 and 104 is about the height of the two outermost vane members 90 and 92. In other words, each of the outermost vane members 90 and 92 is angled relative to the circumferential direction of travel of the rotor 36 by each of the outermost vane members 90 and 92 leading edges being angled relative to its respective trailing edge. Each of the vane members 90, 92, 100, and 104 has a leading edge 108, as shown in FIGS. 3 and 6, forming an acute angle relative to the surface 44 of the rotor 36 and has a top edge with the same radius of curvature as the screen 40.

An angled vane member as defined by this invention is an at least partial radially extending structure on a rotor, the structure being angled in the rotor circumferential direction, the structure creating a positive pressure on the upstream side of the structure and a negative pressure on the downstream side of the structure without including any appreciable pulp lifting body. The pressure difference across the vane creates a free vortex that keeps the screen surface clear.

A pulp lifting body as defined herein is an at least partially circumferential extending rotor structure that turns fluid flow into some physical force on the structure thereby creating a pressure pulse.

The described embodiment is for fiber concentrations of 1% to 6% and will operate at rotational velocities such that the speed of the vane members, as measured at the closed point to the screen cylinder surface, can be 10-35 meters/second.

For fiber concentrations of 0.25-1.5% being processed immediately prior to a paper machine, a different hub design (not shown) is required due to the volume of fiber suspension required per time unit. This embodiment would be a central rotor shaft having radially extended arms supporting relatively thin flat plates on which would be mounted vane members as describe above. Coverage of the screen cylinder surface would also be as noted above. In other words, each of the sets of vane members can be attached to separate curved pieces forming a curved surface coextensive with the set of vane members, with each curved surface piece being supported above the rotor surface, would could constitute a central rod, by an arm extending between the curved surface piece and the central rod.

FIGS. 4 and 5 demonstrate the operation of the invention. The invention claimed is a novel method for screening fibrous suspensions in a pressure screen 40 utilizing the principle of strong, stable vortices to replace conventional pressure pulse generation as the motive force for turbulent de-flocculation, shear stress development, and screen cylinder aperture 42 clearance. Analysis of the vortex effect has shown the vortices 88 alone are capable of allowing operation of a pressure screen 40 in the absence of pressure pulses of sufficient magnitude to otherwise clear the screen 40.

Various other features and advantages of the invention will be apparent from the following Claims.

1. A rotor adapted for use in a hydrodynamic device comprising a screen having a circumferentially continuous apertured zone in a screen surface,
said rotor having a longitudinal axis of rotation and including an outer surface, and further including
a plurality of radially extending, relative to said rotor axis, sets of vane members supported above the rotor surface, said rotor being mounted within and co-axial with the screen to define a screening chamber between said rotor surface and said screen, said plurality of sets of vane members being spaced out throughout said screening chamber in the direction of said rotor axis, with each set of vane members including at least two adjacent but spaced apart vane members, and said rotor outer surface not having longitudinally extending lifting bodies producing pressure pulses throughout said screening chamber.

2. The rotor of claim 1, wherein each of said sets include at least four vane members with spaced apart and parallel trailing edges ending in a common plane, with the two outermost vane members having leading edges forward of the two innermost vane members, said leading edges forward of the two innermost vane members being angled toward its next adjacent vane member.

3. The rotor of claim 2, wherein the height of the two innermost vane members are about the height of the two outermost vane members.

4. The rotor of claim 1, wherein each of said vane members has a leading edge forming an acute angle relative to the surface of said rotor.

5. The rotor of claim 1, wherein each of said vane members has a top edge with the same radius of curvature as said screen.

6. The rotor of claim 1, wherein some of said vane members are angled relative to the circumferential direction of travel of the rotor.

7. The rotor of claim 1, wherein some of said vane members have a leading edge that is angled relative to its trailing edge.

8. The rotor of claim 1, wherein each of said vane members is supported above the rotor surface by being attached to the rotor surface.

9. The rotor of claim 1, wherein said rotor surface is adjacent said screen surface.

10. A rotor adapted for use in a hydrodynamic device comprising a screen having a circumferentially continuous apertured zone in a screen surface,
said rotor having a longitudinal axis of rotation and including a cylindrical outer surface adjacent said screen surface, and further including
a plurality of radially extending directly from said rotor outer surface, relative to said rotor axis, sets of vane members supported above the rotor surface, said rotor being mounted within and co-axial with the screen to define a screening chamber between said rotor surface and said screen, said plurality of sets of vane members being spaced out throughout said screening chamber in the direction of said rotor axis, with each set of vane members including at least two adjacent but spaced apart vane members.

11. A rotor adapted for use in a hydrodynamic device comprising a screen having a circumferentially continuous apertured zone,
said rotor having a longitudinal axis of rotation and including an outer surface, and further including
a plurality of sets of radially extending, relative to said rotor axis, adjacent vane members, each set including at least four adjacent vane members with equally spaced apart and parallel trailing edges ending in a common plane and supported above the rotor surface, with the two outermost vane members having leading edges forward of the two most inside vane members, said leading edges forward of the two most inside vane members being angled toward its next adjacent vane, and the height of the two innermost vane members being about the height of the two outermost vane members, wherein each of said outermost vane members is angled relative to the circumferential direction of travel of the rotor by each of said outermost having vane members with a leading edge that is angled relative to its trailing edge, and wherein each of said vane members has a leading edge forming an acute angle relative to the surface of said rotor and has a top edge with the same radius of curvature as said screen, said rotor being mounted within and co-axial with the screen to define a screening chamber between said rotor surface and said screen, said plurality of sets of vane members being spaced out throughout said screening chamber in the direction of said rotor axis and said rotor outer surface not having longitudinally extending lifting bodies producing pressure pulses throughout said screening chamber.

12. The rotor of claim 11, wherein each of said vane members is supported above the rotor surface by being attached to the rotor surface.

13. The rotor of claim 11, wherein said rotor surface is adjacent said screen surface.
